(19) United States
(12) Patent Application Publication
(10) Pub. No.: US 2009/0316543 A1
(43) Pub. Date: Dec. 24, 2009

(54) OPTICAL PICKUP, OPTICAL INFORMATION REPRODUCING APPARATUS AND OPTICAL INFORMATION REPRODUCING METHOD

(75) Inventors: Kazuya Hayashibe, Saitama (JP); Hiroshi Uchiyama, Miyagi (JP); Takao Kudo, Miyagi (JP); Yusuke Suzuki, Miyagi (JP); Norihiro Tanabe, Kanagawa (JP); Kimihiro Saito, Saitama (JP)

Correspondence Address: WOLF GREENFIELD & SACKS, P.C., 600 ATLANTIC AVENUE, BOSTON, MA, 02210-2206, US

(73) Assignee: Sony Corporation, Tokyo (JP)

(21) Appl. No.: 12/486,024

(22) Filed: Jun. 17, 2009

(30) Foreign Application Priority Data
Jun. 23, 2008 (JP) 2008-163475

(51) Int. Cl. G11B 20/00; G11B 7/00

(52) U.S. Cl. 369/47.15; 369/112.23; G9B/7; G9B/20

(57) ABSTRACT

An optical pickup includes: a light source that emits first light; an objective lens that condenses the first light and allows it to irradiate a track having formed therein a recording mark for intercepting the first light in a uniform recording layer of an optical information recording medium; and a light receiving section that receives transmitted light which has transmitted through the track.

### BACKGROUND OF THE INVENTION

1. Field of the Invention

The present invention relates to an optical pickup, an optical information reproducing apparatus and an optical information reproducing method and is desirably applied to, for example, an optical disc apparatus for reproducing information from an optical disc having a recording mark formed on a uniform recording layer.

2. Description of the Related Art

In optical disc apparatus, there have hitherto been widely spread conventional type optical discs having a signal recording layer, such as CD (compact disc), DVD (digital versatile disc) and Blu-ray Disc (a registered trademark; hereinafter referred to as “BD”). In such an optical disc apparatus, the information is reproduced by irradiating a desired track on which a light beam is to be irradiated in the signal recording layer (this track will be hereinafter referred to as “desired track”) with a light beam and reading reflected light thereof.

In such a conventional type optical disc apparatus, the information is recorded by irradiating the signal recording layer of the optical disc with a light beam and changing a local reflectance or the like of the subject signal recording layer.

Now, various kinds of information including various contents such as music contents and video contents and various data for computers are recorded in an optical disc. In particular, in recent years, the amount of information is increased because of high definition of video data and high quality of music data, and an increase of the number of contents to be recorded in a single optical disc is required. Accordingly, the optical disc is required to have a further increased capacity.

Then, among optical disc apparatus, there has been proposed an optical disc apparatus by recording a standing wave as a recording mark within a uniform recording layer of the optical disc while utilizing, for example, holograms and making it multilayered, thereby attempting to realizing simplification and large capacity of the optical disc (see, for example, JP-A-2008-71433).

Such an optical disc apparatus emits a light beam on an irradiation line connecting to the center of the recording mark in the optical disc and receives return light from the subject recording mark. Then, the optical disc apparatus detects the presence or absence of a recording mark on the basis of the return light and reproduces the information.

### SUMMARY OF THE INVENTION

Now, an optical disc corresponding to an optical disc apparatus having such a configuration does not have a signal recording layer and is uniform within a recording layer, and therefore, there may be the case where a recording mark formed within the recording layer is formed deviated in the thickness direction of the optical disc. In that case, there was involved a problem that return light having the quantity of light of a prescribed amount or more cannot be obtained from the recording mark, thereby causing a lowering of the quality of reproduced signals.

In view of the foregoing problems of the related art, it is desirable to provide an optical pickup capable of enhancing the quality of reproduced signals, an optical information reproducing apparatus and an optical information reproducing method.

In order to achieve the foregoing desire, according to an embodiment of the present invention, there is provided an optical pickup including: a light source that emits first light; an objective lens that condenses the first light and allowing it to irradiate a track having formed therein a recording mark for intercepting the first light in a uniform recording layer of an optical information recording medium; and a light receiving section that receives transmitted light which has transmitted through the track.

According to this, in the optical pickup, the quantity of light largely fluctuates depending upon the presence or absence of a recording mark, and transmitted light with a large degree of modulation is received, whereby a reproduced signal can be produced on the basis of the subject transmitted light.

Also, according to another embodiment of the present invention, there is a provided an optical information reproducing apparatus including: a light source that emits first light; an objective lens that condenses the first light and allowing it to irradiate a track having formed therein a recording mark for intercepting the first light in a uniform recording layer of an optical information recording medium; a light receiving section that receives transmitted light which has transmitted through the track; and a signal processing section that produces a reproduced signal on the basis of the transmitted light.

According to this, in the optical information reproducing apparatus, the quantity of light largely fluctuates depending upon the presence or absence of a recording mark, whereby a reproduced signal can be produced on the basis of transmitted light with a large degree of modulation.

Furthermore, according to still another embodiment of the present invention, there is a provided an optical information reproducing method including the steps of condensing first light and allowing it to irradiate a track having formed therein a recording mark for intercepting the first light in a uniform recording layer of an optical information recording medium; and receiving transmitted light which has transmitted through the track.

According to this, in the optical information reproducing method, the quantity of light largely fluctuates depending upon the presence or absence of a recording mark, and transmitted light with a large degree of modulation can be received, whereby a reproduced signal can be produced on the basis of the subject transmitted light.

According to the embodiments of the present invention, it is possible to realize an optical pickup in which the quantity of light largely fluctuates depending upon the presence or absence of a recording mark, and transmitted light with a large degree of modulation is received, whereby a reproduced signal can be produced on the basis of the subject transmitted light, and the recording mark can be detected in a high precision, an optical information reproducing apparatus and an optical information reproducing method.

### BRIEF DESCRIPTION OF THE DRAWINGS

FIG. 1 is a schematic view showing a configuration of an optical disc according to a first embodiment.

FIG. 2 is a schematic view to be provided for explaining initialization of an optical disc.

FIGS. 3A and 3B are each a schematic view showing a configuration of an optical information recording medium.

FIGS. 4A, 4B and 4C are each a schematic view showing the state of a recording mark.

FIG. 5 is a schematic view to be provided for explaining a focus of a recording light beam and a beam waist.

FIG. 6 is a schematic view showing intensity distribution of a transmitted light receiving signal.

FIG. 7 is a schematic view showing intensity distribution of a reflected light receiving signal.

FIGS. 8A and 8B are each a schematic view to be provided for explaining irradiation of an optical information recording medium with a light beam according to a first embodiment.

FIG. 9 is a schematic view showing a configuration of an optical information recording and reproducing apparatus.

FIG. 10 is a schematic view showing a configuration of an optical pickup according to a first embodiment.

FIG. 11 is a schematic view to be provided for explaining a deviation of a focus position due to an inclination of an optical information recording medium.

FIG. 12 is a schematic view showing a configuration of an optical information recording medium according to a second embodiment.

FIG. 13 is a schematic view to be provided for explaining irradiation of an optical information recording medium with a light beam according to a second embodiment.

FIG. 14 is a schematic view showing a configuration of an optical pickup according to a second embodiment.

### DESCRIPTION OF THE PREFERRED EMBODIMENTS

Embodiments of the present invention are hereunder described in detail with reference to the accompanying drawings.

### (1) First Embodiment

### (1-1) Configuration of Optical Disc

First of all, an optical information recording medium 100 which is used as an optical information recording medium in an embodiment according to the present invention is described. Similar to the conventional CD, DVD and BD, the optical information recording medium 100 is configured in a disc shape having a diameter of about 120 mm as a whole and is provided with an opening 100H in a central portion thereof.

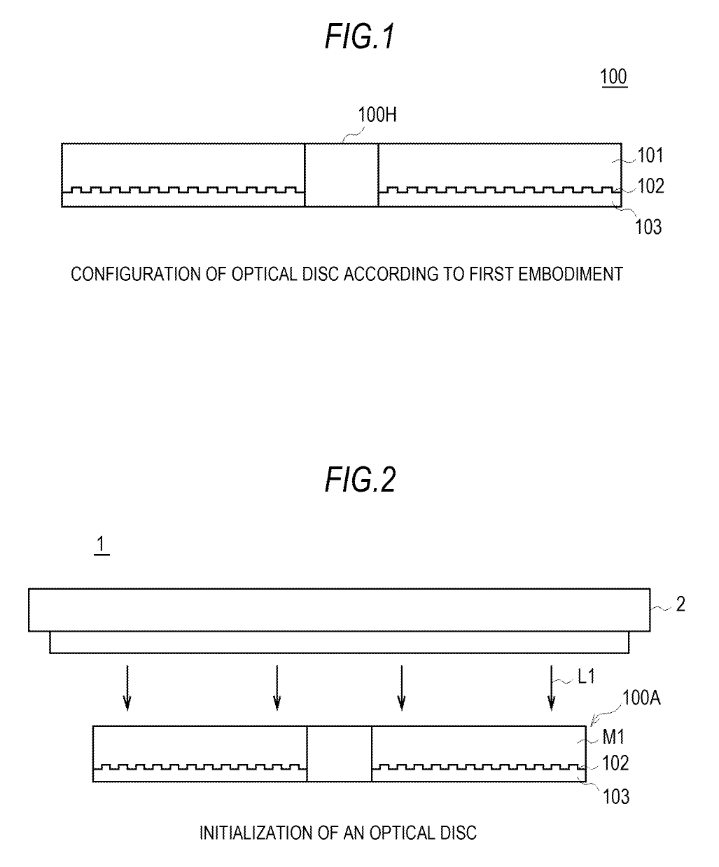

Also, as shown in a cross-sectional view of FIG. 1, the optical information recording medium 100 is configured such that a servo layer 102 is interposed from the both surfaces thereof by a recording layer 101 for recording information and a substrate 103. A thickness t1 of the recording layer 101 and a thickness t3 of the substrate 103 are each properly chosen so as to fall within the range of from 0.05 mm to 1.15 mm.

The substrate 103 is made of a material of, for example, a polycarbonate, glass, etc. and configured such that light which is made incident from one surface thereof transmits toward the opposite surface thereto in a high transmittance.

Also, the optical information recording medium 100 is provided with the servo layer 102 as a reflection layer at the interface between the recording layer 101 and the substrate 103. The servo layer 102 is made of a dielectric multilayered film or the like and reflects all of an information light beam LM composed of blue laser light with a wavelength of 405 nm and a servo light beam LS composed of red laser light with a wavelength of 660 nm.

Also, the servo layer 102 forms a helical servo track by a guide groove (namely, land and groove) similar to general BD-R (recordable) discs and the like. This servo track is given an address composed of a series of numbers for every prescribed recording unit, whereby a position of the subject servo track in the optical information recording medium 100 can be specified by the subject address. The guide groove may be replaced by a pit or like, or a combination of a guide groove and a pit or the like.

The recording layer 101 forms a recording mark RM corresponding to irradiation with an information light beam LM with an intensity of a prescribed value or more to be used at the time of recording information (this light beam will be hereinafter referred to as “recording light beam LMw”). This recording mark RM intercepts an information light beam LM with a relatively low intensity to be used at the time of reproducing information (this light beam will be hereinafter referred to as “read-out light beam LMe”) by means of reflection, diffraction and absorption.

As this recording mark RM, for example, refractive index modulation for changing a refractive index against the surroundings is useful. In that case, it is preferable that a vaporizable material having a vaporization temperature at from 140° C. to 400° C. by means of boiling, decomposition or the like, for example, a photopolymerization initiator, a residual solvent, a monomer, etc. is blended in the recording layer 101, thereby diffusing the vaporizable material having a vaporization temperature at from 140° C. to 400° C. in the recording layer 101 after initialization.

When the recording layer 101 is irradiated with an information light beam LM for prescribed recording (this light beam will be hereinafter referred to as “recording light beam LMw”) through an objective lens, the temperature in the vicinity of a focus Fb of the recording light beam LMw locally increases and becomes high, for example, 140° C. or higher. At that time, the recording light beam LMw is able to locally change a refractive index of the focus Fb by means of evaporation or decomposition reaction of the vaporizable material contained in the recording layer 101 in the vicinity of the focus Fb.

Also, there may be the case where a bubble is formed by changing the refractive index of the vaporizable material in the vicinity of the focus Fb or increasing the volume of the subject vaporizable material. At that time, the vaporized photopolymerization initiator residue transmits through the inside of the recording layer 101 as it is, or is cooled due to the fact that it is not irradiated with the recording light beam LMw, and returns to a liquid with a small volume. For that reason, in the recording layer 101, only a cavity formed by the bubble remains in the vicinity of the focus Fb. Since the resin as in the recording layer 101 generally makes air permeate therethrough at a fixed rate, it may be thought that the inside of the cavity is fulfilled with air in due course.

That is, in the optical information recording medium 110, the recording mark RM with an altered refractive index of the focus Fb can be formed by being irradiated with the recording light beam LMw to vaporize the vaporizable material contained in the recording layer 101.

It is preferred to use, as this vaporizable material, a vaporizable material having a vaporization temperature of from 140° C. to 400° C.

That is, in the case of using a vaporizable material having a low vaporization temperature, due to the fact that the photopolymerization initiator residue existing in the vicinity of the focus Fb is increased to about the vaporization temperature or higher upon irradiation with the recording light beam LMw, the vaporizable material is vaporized, whereby the recording mark RM can be formed.

Also, it may be thought that the vaporizable material is vaporized by heat generated by the recording light beam LMw. Accordingly, in fact, a vaporizable material having a relatively low vaporization temperature tends to have a shorter recording time than that of a vaporizable material having a high vaporization temperature. Thus, it may also be thought that the lower the vaporization temperature of the vaporizable material, the easier the formation of the recording mark RM is.

However, in general vaporizable materials, it is affirmed that an endothermic reaction starts step by step from about 90° C., the temperature of which is about 60° C. lower than the vaporization temperature. This suggests that in the case of allowing the optical information recording medium 100 containing a vaporizable material to stand at a temperature of about 90° C. for a long period of time, the vaporizable material volatilizes step by step, whereby at the time when it is intended to form the recording mark RM, the vaporizable material does not possibly remain within the recording layer 101. In this way, in the recording layer 101 in which no vaporizable material remains, even when the subject recording layer 101 is irradiated with the recording light beam LMw, the recording mark RM cannot be formed.

It is supposed that a general electronic appliance is used at a temperature of about 80° C. Accordingly, in order to secure the temperature stability as the optical information recording medium 100, it is preferred to use a photopolymerization initiator having a vaporization temperature of 140° C. (80° C.+60° C.) or more. Also, it may be thought that the temperature stability can be further enhanced by using a vaporizable material having a vaporization temperature of about 5° C. higher than 140° C. (namely, 145° C.)

In the light of the above, the vaporization temperature of the photopolymerization initiator which is blended in a liquid material M1 is preferably from 140° C. to 400° C., and especially preferably from 145° C. to 300° C.

For the purposes of stably forming the recording mark RM and preventing harmful influences such as a lowering of elastic modulus of the recording layer 101 to be caused due to the excessive presence of a vaporizable material, the blending amount of the vaporizable material is preferably from 0.8 parts by weight to 40.0 parts by weight, and especially preferably from 2.5 parts by weight to 20.0 parts by weight based on 100 parts by weight of the monomer.

It is preferred to use, as the vaporizable material, a photopolymerization initiator capable of generating a radical, a cation or an anion depending upon the irradiation with light having a wavelength of from 100 nm to 800 nm. This is because it may be thought that such a photopolymerization initiator is able to make the resin material permeate therethrough and absorb the recording light beam LMw to generate heat.

The recording layer 101 is obtained by diffusing the foregoing vaporizable material into a binder component such as a photopolymer which is polymerized with light, a resin with heat or a resin material of a thermal crosslinking type which is crosslinked with heat (this resin will be hereinafter referred to as “thermosetting resin”), and a thermoplastic resin which is plasticized by heating.

For example, in the case of using a photopolymer as the binder component of the recording layer 101, for example, when the liquid material M1 in an uncured state (as described later in detail) which is capable of forming a photopolymer by polymerization is spread in an upper part of the substrate 103 having a guide groove formed thereon, the optical information recording medium 100 in which a portion corresponding to the recording layer 101 in FIG. 1 is made of the liquid material M1 in an uncured state (this optical information recording medium will be hereinafter referred to as “uncured optical information recording medium 100A) is formed.

In the liquid material M1, for example, a resin material of a photopolymerization type or photo-crosslinking type (this resin material will be hereinafter referred to as “photo-setting resin”) which constitutes a part or the majority of the liquid material M1 is constituted of, for example, a radical polymerization type monomer and a radical generating type photopolymerization initiator, a cationic polymerization type monomer and a cation generating type photopolymerization initiator, or a mixture thereof.

Also, as to these photopolymerization type monomer, photo-crosslinking type monomer and photopolymerization initiator, in particular, the photopolymerization initiator, by adequately selecting a material thereof, it is possible to regulate the wavelength at which photopolymerization easily occurs at a desired wavelength. The liquid material M1 may contain suitable amounts of various additives such as a polymerization inhibitor for the purpose of preventing the initiation of the reaction to be caused due to non-intended light and a polymerization promoter for promoting the polymerization reaction.

That is, either one or both of a monomer and an oligomer (this will be hereinafter referred to as “monomer”) are uniformly dispersed in the inside of the liquid material M1. This liquid material M1 has properties such that when irradiated with light, it becomes a photopolymer due to the fact that the monomer is polymerized (namely, photopolymerized) in the irradiated area, whereby its refractive index and reflectance are changed. Also, there may be the case where the refractive index and reflectance of the liquid material M1 are further changed due to the fact that so-called photo-crosslinking in which “crosslinking” occurs between photopolymers each other upon irradiation with light, whereby the molecular weight increases, is generated.

Known monomers can be used as this monomer. Monomers which are used for a radical polymerization reaction, for example, styrene and vinylnaphthalene derivatives as well as acrylic acid, acrylic acid ester and acrylic acid amide derivatives are chiefly useful as the radical polymerization type monomer. Also, compounds having an acrylic monomer in a urethane structure are applicable. Also, derivatives obtained by substituting the hydrogen atom with a halogen atom in the foregoing monomers may be used.

Specifically, known compounds, for example, acryloyl morpholine, phenoxyethyl acrylate, isobornyl acrylate, 2-hydroxypropyl acrylate, 2-ethylhexyl acrylate, 1,6-hexanediol diacrylate, tripropylene glycol diacrylate, neopentyl glycol PO-modified diacrylate, 1,9-nonanediol diacrylate, hydroxypivalic acid neopentyl glycol diacrylate, acrylic acid esters, fluorene acrylate, urethane acrylate, octyl fluorene, benzyl acrylate, etc. can be used as the radical polymerization type monomer. These compounds may be monofunctional or polyfunctional.

Also, the cationic polymerization type monomer may be a monomer having a functional group such as an epoxy group and a vinyl group. Known compounds, for example, epoxycyclohexylmethyl acrylate, epoxycyclohexylmethyl acrylate, fluorene epoxy, glycidyl acrylate, vinyl ether, oxetane, etc. can be used as cationic polymerization type monomer.

Known compounds, for example, 2,2-dimethoxy-1,2-diphenylethane-1-one, 1-[4-(2-hydroxyethoxy)-phenyl]-2-hydroxy-2-methyl-1-propane-1-one, bis(2,4,6-trimethylbenzoyl)-phenylphosphine oxide, etc. can be used as the radical generating type photopolymerization initiator.

Known compounds, for example, diphenyl iodonium hexafluorophosphate, tri-p-trisulfonium hexafluorophosphate, cumyl tolyliodonium hexafluorophosphate, cumyl tolyliodonium tetrakis(pentafluorophenyl)boron, etc. can be used as the cation generating type photopolymerization initiator.

In the case of using the cation polymerization type monomer and the cation generating type photopolymerization initiator, a curing shrinkage factor of the liquid material M1 can be reduced as compared with the case of using the radical polymerization type monomer and the radical generating type photopolymerization initiator. Also, it is possible to use a combination of an anion type monomer and an anion type photopolymerization initiator as the photopolymerization type or photo-crosslinking type resin material.

In an initializing apparatus 1 as shown in FIG. 2, the uncured optical information recording medium 100A works so as to function as the recording layer 101 such that the liquid material M1 is initialized by initializing light L1 which is emitted from an initializing light source 2, thereby recording a recording mark.

Specifically, the initializing apparatus 1 works so as to emit the initializing light L1 having a wavelength of, for example, 365 nm (300 mW/cm², DC (direct current) output) from the initializing light source 2 and irradiate the optical information recording medium 100 in a plate form which is placed on a table 3 with the subject initializing light L1. The wavelength and light power of this initializing light L1 are properly chosen such that they are optimal depending upon the kind of the photopolymerization initiator which is used for the liquid material M1 and the thickness t1 of the recording layer 101.

A light source capable of emitting a high light power, for example, a high pressure mercury lamp, a high pressure metal halide lamp, a solid laser, a xenon lamp, a semiconductor laser, etc. is used as the initializing light source 2 and works so as to uniformly irradiate the whole of the uncured optical information recording medium 100A with the initializing light L1.

At that time, the liquid material M1 initiates either one or both of a photopolymerization reaction and a photo-crosslinking reaction of the monomer by generating a radical or a cation from the photopolymerization initiator within the subject liquid material M1 (these reactions will be hereinafter collectively referred to as “photoreaction”) and also serially advances a photopolymerization and crosslinking reaction of the monomer. As a result, the monomer is polymerized to form a photopolymer, whereby the liquid material M1 is cured to form the recording layer 101.

In this liquid material M1, since the photoreaction is substantially uniformly caused as a whole, the refractive index in the recording layer 101 after curing becomes uniform. That is, in the optical information recording medium 100 after initialization, even when any area is irradiated with light, the quantity of light of return light or transmitted light becomes uniform, and therefore, a state that information is not recorded at all is produced.

Also, a resin material of a thermal polymerization type which is polymerized with heat or a resin material of a thermal crosslinking type which is crosslinked with heat (this resin will be hereinafter referred to as “thermosetting resin”) can be used as the recording layer 101. In that case, as to the liquid material M1 which is a thermosetting resin before curing, for example, a monomer and a curing agent or a thermal polymerization initiator are uniformly dispersed in the inside thereof. This liquid material M1 has properties such that it becomes a photopolymer due to the fact that the monomer is polymerized or crosslinked at a high temperature or normal temperature (this phenomenon will be hereinafter referred to as “thermosetting”), whereby its refractive index and reflectance are changed.

In fact, the liquid material M1 is constituted by, for example, adding a prescribed amount of the foregoing photopolymerization initiator to a thermosetting type monomer capable of forming a polymer and a curing agent. It is preferable that a material which is cured at normal temperature or cured at a relatively low temperature such that the photopolymerization initiator is not vaporized is used as the thermosetting type monomer and the curing agent. Also, it is possible to previously cure the thermosetting resin by heating before adding the photopolymerization initiator.

Known monomers can be used as the monomer which is used for the thermosetting resin. There are useful various monomers which are used as a material for, for example, phenol resins, melamine resins, urea resins, polyurethane resins, epoxy resins, unsaturated polyester resins, etc.

Also, known curing agents can be used as the curing agent which is used for the thermosetting resin. There are useful various curing agents, for example, amines, polyamide resins, imidazoles, polysulfide resins, isocyanates, etc. The curing agent is properly chosen depending upon the reaction temperature and characteristics of the monomer. There may be used various additives such as a curing assistance for promoting the curing reaction.

Furthermore, a thermoplastic resin material can be used as the recording layer 101. In that case, the liquid resin M1 which is spread on the substrate 103 is constituted by, for example, adding a prescribed amount of the foregoing photopolymerization initiator to a polymer diluted with a prescribed diluting solvent.

Known resins can be used as the thermoplastic resin material. There are useful various resins, for example, olefin resins, vinyl chloride resins, polystyrenes, ABS (acrylonitrile-butadiene-styrene copolymer) resins, polyethylene terephthalate, acrylic resins, polyvinyl alcohols, vinylidene chloride resins, polycarbonate resins, polyamide resins, acetal resins, norbornene resins, etc.

Also, various solvents such as water, alcohols, ketones, aromatic solvents and halogen based solvents or mixtures thereof can be used as the diluting solvent. There maybe added various additives, for example, a plasticizer capable of changing physical characteristics of the thermoplastic resin.

From the viewpoints of workability and storage capacity, the recording layer 101 preferably has a thickness of 0.05 mm or more and not more than 1.0 mm. Also, the additional thickness of the substrate 102 through which light passes and the recording layer 101 is preferably not more than 1.2 mm. This is because in the case where the thickness exceeds 1.2 mm, when the surface of the optical information recording medium 100 is inclined, astigmatism of the recording light beam LMw which is generated within the subject optical information recording medium 100 becomes large.

Also, when the recording mark RM existing on a target tack TG is irradiated with the information light beam LM for reading information (hereinafter referred to as “read-out light beam LMe”), the recording layer 101 reflects the read-out light beam LMe due to a difference in refractive index at the interface of the subject recording mark RM.

As a result, the recording mark RM intercepts the read-out light beam LMe and reduces the quality of light of the read-out light beam LMe which has transmitted through the target track TG (this read-out light beam will be hereinafter referred to as “transmitted light beam LMo”). On the other hand, the recording mark RM reflects the read-out light beam LMe and generates a part thereof as a return light beam LMt which is traveled in an opposite direction to the subject read-out light beam LMe.

On the other hand, when a prescribed target mark position where the recording mark is not recorded on the target track is irradiated with a light beam L2 for reading (hereinafter referred to as “read-out light beam LMe”), the recording layer 101 does not reflect the read-out light beam LMe due to the fact that the vicinity of the target mark position has a uniform refractive index.

As a result, the recording layer 101 does not reduce the quantity of light of the transmitted light beam LMo without intercepting the read-out light beam LMe. On the other hand, the recording layer 101 does not generate the return light beam LMt because it does not reflect the read-out light beam LMe.

That is, the optical information recording medium 100 works such that by irradiating the target position of the recording layer 101 with the read-out light beam LMe and detecting the quantity of light of the transmitted light beam LMo which has been transmitted by the recording layer 101 or the return light beam LMt which has been reflected by the recording layer 101, the presence or absence of the recording mark RM in the recording layer 101 can be detected, and the information recorded in the recording layer 101 can be reproduced.

### (1-2) Light Receiving of Transmitted Light Beam and Reflected Light Beam

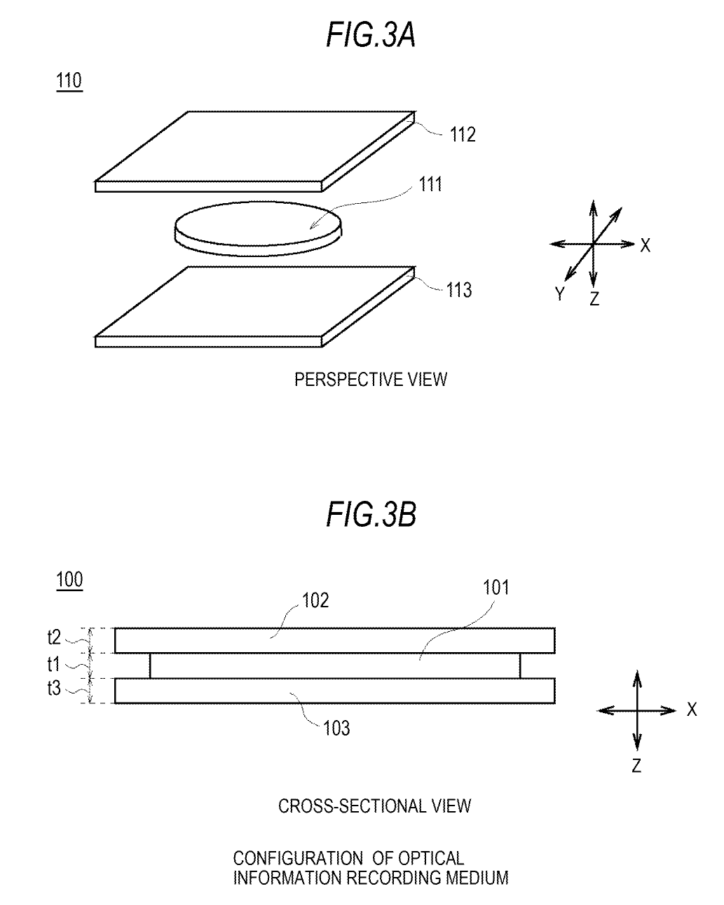

Next, not only was an optical information recording medium 110 corresponding to the foregoing optical information recording medium 100 actually prepared, but also information was recorded and reproduced. For the sake of convenience of the preparation, as shown in FIG. 3A, the optical information recording medium 110 was formed by interposing a recording layer 111 corresponding to the recording layer 101 by substrates 112 and 113.

Specifically, a glass in a substantially square shape with about 50 mm in one side and 0.5 mm and 0.7 mm in thicknesses t2 and t3, respectively was prepared as the substrates 112 and 113.

Also, a mixture of an acrylic acid ester monomer (p-cumylphenol ethylene oxide-added acrylic acid ester) and a fluorene bifunctional epoxy (EX1020, manufactured by Osaka Gas Chemicals Co., Ltd.) (weight ratio: 60/40) was prepared as the monomer. Furthermore, 1.0 part by weight of cumyl tolyliodonium tetrakis(pentafluorophenyl)boron as the photopolymerization initiator was added to 100 parts by weight of the subject mixture and mixed and degassed in a dark room to prepare the liquid material M1.

The liquid material M1 was then spread on the substrate 113 and interposed between the substrates 112 and 113 to prepare an uncured optical information recording medium 110a corresponding to the uncured optical information recording medium 100A. This uncured optical information recording medium 110a was irradiated with initializing light L1 with a power density of 42 mW/cm² at a wavelength of 365 nm for 60 seconds from the initializing light source 1 composed of a high pressure mercury lamp, thereby preparing the optical information recording medium 110. The recording layer 111 had a thickness t1 of 0.3 mm.

The recording layer 111 in this optical information recording medium 110 was irradiated with the recording light beam LMw having a wavelength of from 402 to 407 nm and a light power of 30 mW for 15 mseconds from the side of the substrate 112 through an objective lens (not illustrated) with a numerical aperture NA of 0.5, thereby preparing the recording mark RM. At that time, the optical information recording medium 110 was irradiated while removing in the x and y directions to deviate the position of the recording light beam L2 by every 4 μm in the x and y directions, respectively, thereby forming the recording mark RM in the number of 20×20 (400 in total) in a matrix form.

A SEM (scanning electron microscope) photograph of each of the cross sections when the recording layer 101 was cut in the xy direction (namely, the layer direction) and xz direction (namely, the thickness direction) so as to go through substantially the center of the recording mark RM was taken.

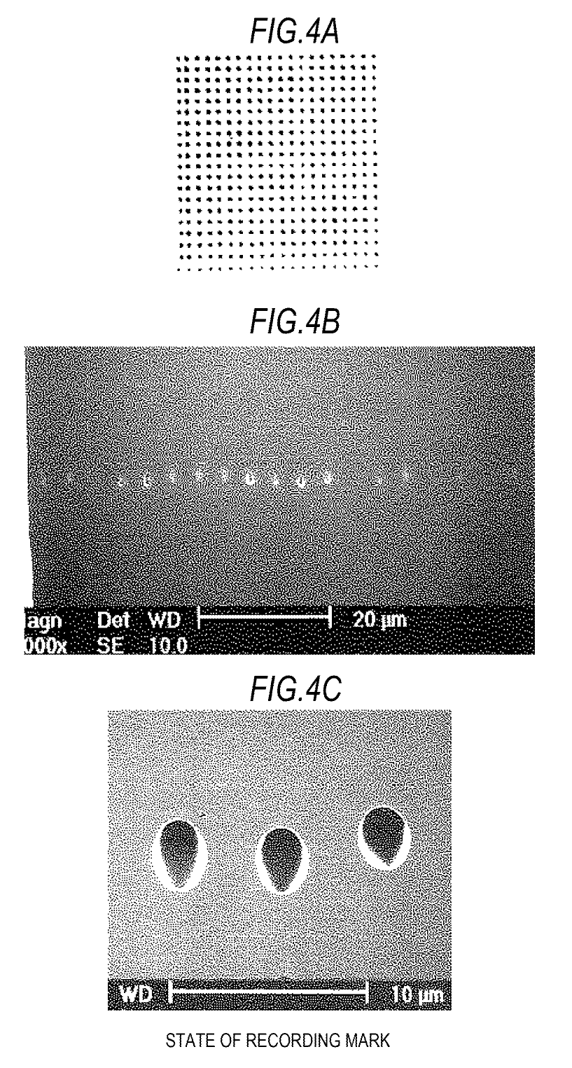

As shown in FIG. 4A, it was confirmed that the recording mark RM was formed arranged orderly in the x direction and y direction. In comparison with other lines, the most left line of the recording mark RM is close to a line of the adjacent recording mark RM due to the problem of position control of the recording light beam LMw.

On the other hand, as shown in FIGS. 4B and 4C, the recording mark RM was formed deviated by every about 1 μm each other in the z direction. It has been confirmed that this phenomenon becomes remarkable as the recording rate increases.

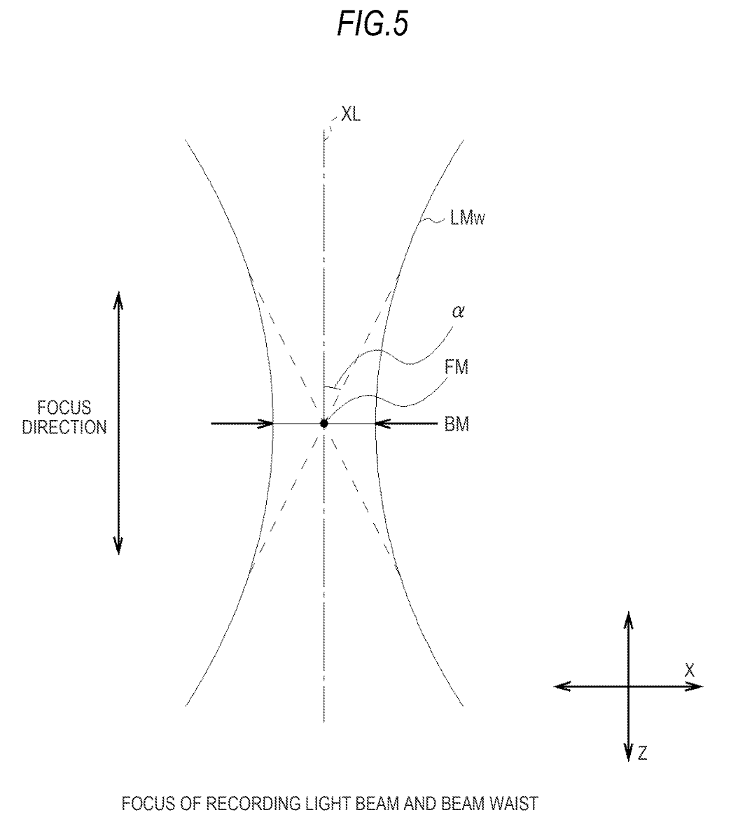

Here, as shown in FIG. 5, the recording light beam LMw does not form a point at the focus Fb but becomes minimum in terms of its diameter (namely, a spot size) in a light beam waist BW including the focus Fb. In the vicinity of this light beam waist BW, the spot size increases extremely slowly as it is isolated from the subject light beam waist BW. That is, as to the recording light beam LMw, it is assumed that in the vicinity of the focus Fb, the change in light intensity in the z direction is smaller than that in the xy direction, and therefore, the recording mark RM is easily deviated.

Next, the optical information recording medium 110 having the recording mark RM formed therein is irradiated with the read-out light beam LMe having a wavelength of from 402 to 407 nm and a light power of 50 μW, while the optical information recording medium 110 was moved at a rate of 300 μm/sec. At that time, a condensing lens with a numerical aperture NA of about 0.6 and a photodiode were placed on the side of the substrate 113, thereby receiving the transmitted light beam LMo having transmitted therethrough the optical information recording medium 110.

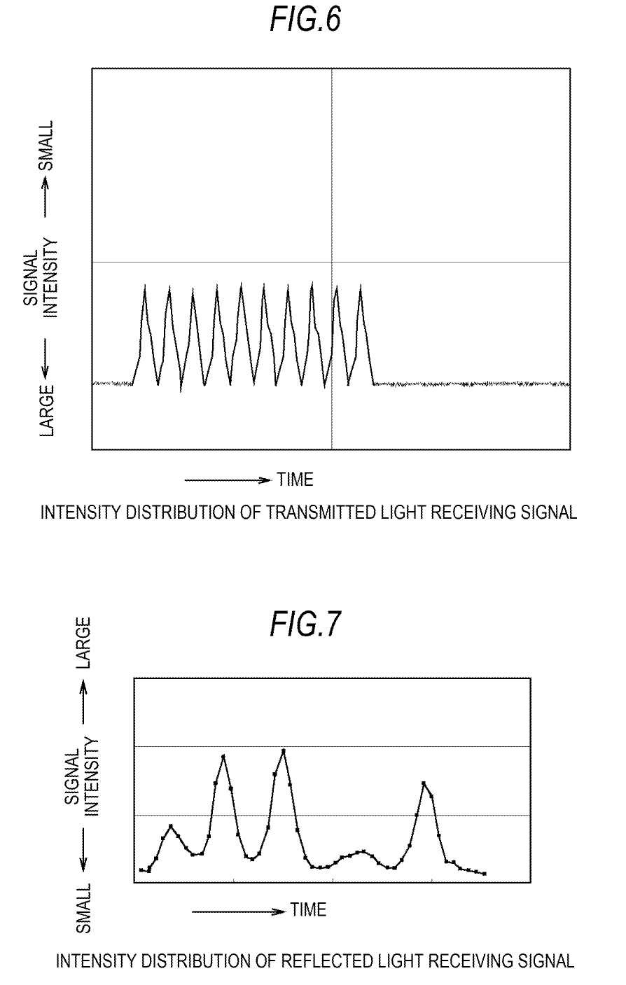

At that time, a light receiving signal obtained from the photodiode (this light receiving signal will be hereinafter referred to as “transmitted light receiving signal”) is shown in FIG. 6. In the transmitted light receiving signal, when the recording mark RM exists, the read-out light beam LMe is intercepted by the subject recording mark RM, whereby the quantity of light of the transmitted light beam LMo is lowered. In FIG. 6, it is expressed that the signal level decreases toward the upper direction of the drawing and that the recording mark RM existed in the vicinity of the maximum value.

Also, a photodiode was placed on the side of the substrate 112, thereby receiving the return light beam LMt reflected by the optical information recording medium 110.

At that time, a light receiving signal obtained from the photodiode (this light receiving signal will be hereinafter referred to as “reflected light receiving signal”) is shown in FIG. 7. In the reflected light receiving signal, since the return light beam LMt is generated upon reflection by the recording mark RM, when the recording mark RM exists, the quantity of light of the return light beam LMt increases. Contrary to FIG. 6, in FIG. 7, the signal level increases toward the upper direction of the drawing, and it is expressed that the recording mark RM existed in the vicinity of the maximum value similar to FIG. 6.

As shown in FIG. 6, in the transmitted light receiving signal, it has been confirmed that the signal level changes in substantially the same amplitude depending upon the recording mark RM. Contrary to this, in the reflected light receiving signal as shown in FIG. 7, it has been confirmed that the amplitude differs depending upon the recording mark RM.

That is, since the return light beam LMt is a part of the read-out light beam LMe having been reflected diffusely by the recording mark RM, its quantity of light is fluctuated by even a very little position change of the recording mark RM. As a result, in the reflected light receiving signal, it may be thought that the amplitude was fluctuated depending upon the position of the recording mark RM in the z direction.

Contrary to this, since the transmitted light beam LMo is composed of the read-out light beam LMe with which the recording mark RM has not been irradiated directly, its quantity of light is not fluctuated by the state of reflection of the read-out light beam LMe, and the quantity of light is not substantially fluctuated by a very little position change of the recording mark RM. For that reason, in the transmitted light receiving signal, it may be thought that the amplitude was constant regardless of the position of the recording mark RM in the z direction.

It has been confirmed from these facts that in the optical information recording medium having a uniform recording layer and capable of forming a recording mark RM with a refractive index modulation to record information, the recording mark RM can be preciously detected by detecting the presence or absence of the recording mark RM on the basis of the transmitted light beam LMo.

### (1-3) Recording and Reproduction of Information

As described previously, the optical information recording medium 100 is provided with the servo layer 102 which reflects all of the information light beam LM and the servo light beam LS.

In the case where this servo layer 102 is irradiated with the servo light beam LS from the side of the recording layer 101, the servo layer 102 reflects the servo light beam LS to the side of the subject recording layer 101. The light beam reflected at that time will be here in after referred to as “servo reflected light beam LSr”.

For example, in an optical information recording and reproducing apparatus 20, it is supposed that for the purpose of making a focus FS of the servo light beam LS condensed by an objective lens 35 in conformity with a desired servo track (hereinafter referred to as “desired servo track”), this servo reflected light beam LSr is used for the position control of the objective lens 35 (namely, focus control and tracking control).

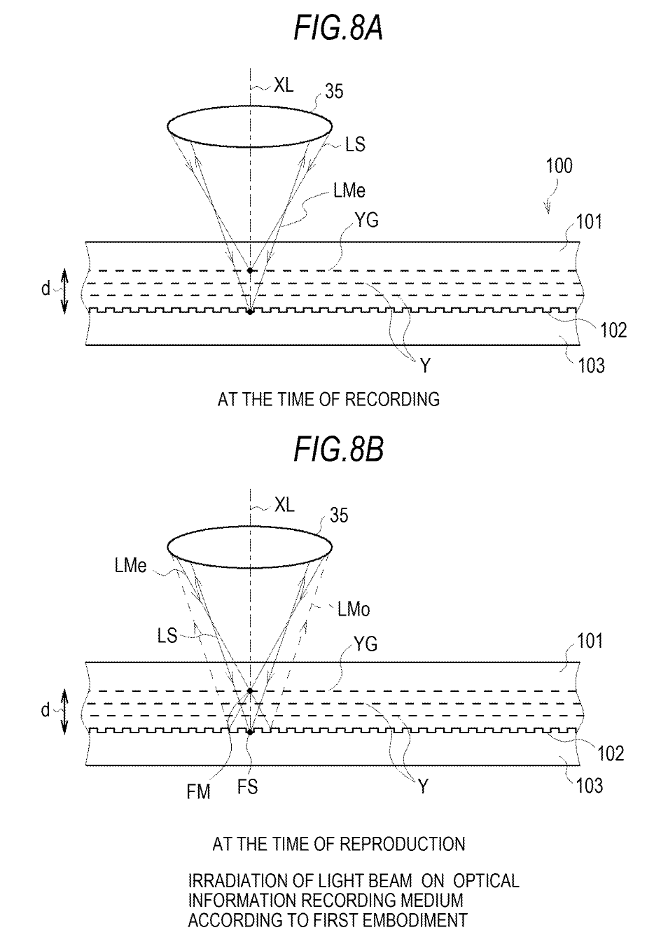

In fact, as shown in FIG. 8A, when information is recorded in the optical information recording medium 100, the servo light beam LS is condensed by the position-controlled objective lens 35 and focused into the desired servo track of the servo layer 102.

Also, the subject servo light beam LS and an optical axis XL are held jointly and condensed by the subject objective lens 35, and the information light beam LM is focused into a track TR corresponding to the subjected desired servo track within the recording layer 101.

Furthermore, in the optical information recording medium 100, a focus FM of the recording light beam LMw to be condensed through the same objective lens 35 is focused into a mark layer corresponding to the “near side” of the subject desired servo track within the recording layer 101 and having a target depth (this mark layer will be hereinafter referred to as “target mark layer YG”). As a result, the optical information recording medium 100 works so as to be focused into a track corresponding to the desired servo track in the target mark layer YG (this track will be hereinafter referred to as “target track TG”).

At that time, in the recording layer 101, in the case where the information light beam LM is the recording light beam LMw which is used at the time of recording processing, the recording mark RM is formed in a portion where the subject recording light beam LMw is condensed to have a prescribed intensity or more (namely, the surroundings of the focus FM).

Furthermore, the optical information recording medium 100 is designed such that the thickness t1 of the recording layer 101 is sufficiently larger than a height RMh of the recording mark RM. For that reason, the optical information recording medium 100 works such that when the recording mark RM is recorded while switching a distance d from the servo layer 102 within the recording layer 101 (this distance will be hereinafter referred to as “depth”), it is able to achieve multilayer recording in which plural mark layers Y are superimposed in the thickness direction of the subject optical information recording medium 100.

On the other hand, as shown in FIG. 8B, in the optical information recording medium 100, when information is reproduced, similar to the time of recording the subject information, not only is the subject objective lens 35 position-controlled such that the servo light beam LS condensed by the objective lens 35 is focused into the desired servo track of the servo layer 102, but also the read-out light beam LMe is focused into the target track TG.

At that time, in the case where the recording mark RM is formed at the focus FM, a part of the read-out light beam LMe is reflected due to a difference in refractive index from the surroundings to make it transmit through the target track TG, thereby forming the transmitted light beam LMo whose quantity of light is reduced. Also, in the case where the recording mark RM is not formed at the focus FM, the read-out light beam LMe transmits through the target track TG as it is without reducing the quantity of light, thereby forming the transmitted light beam LMo. The servo layer 102 is irradiated with this transmitted light beam LMo as it is.

The servo layer 102 deflects the traveling direction thereof by 180 degrees by reflecting the transmitted light beam LMo and makes the transmitted light beam LMo traveling in the opposite direction to the read-out light beam LMe incident into the objective lens 35. Here, in the transmitted light beam LMo, the quantity of light is fluctuated by the presence or absence of the recording mark RM. Accordingly, by detecting the quantity of light of the transmitted light beam LMo, it is possible to detect the presence or absence of the recording mark RM.

In this way, in the optical information recording medium 100, when information is recorded, the servo light beam LS for position control and the recording light beam LMw for information recording are used. According to this, the optical information recording medium 100 works such that the recording mark RM is formed as the subject information at a position within the recording layer 101 where it is irradiated with the recording light beam LMw, namely the target track TG positioning on the near side of the desired servo track in the servo layer 102 and having the target depth.

Also, in the optical information recording medium 100, when the recorded information is reproduced, the servo light beam LS for position control and an information light beam LMr for reading are used. According to this, the optical information recording medium 100 is able to fluctuate the quantity of light of the transmitted light beam LMo depending upon the position of the focus FM, namely the presence or absence of the recording mark RM recorded on the target track TG. As a result, the optical information recording medium 100 works such that it is able to detect the presence or absence of the recording mark RM on the basis of the quantity of light of the transmitted light beam LMo.

### (1-4) Configuration of Optical Disc Apparatus

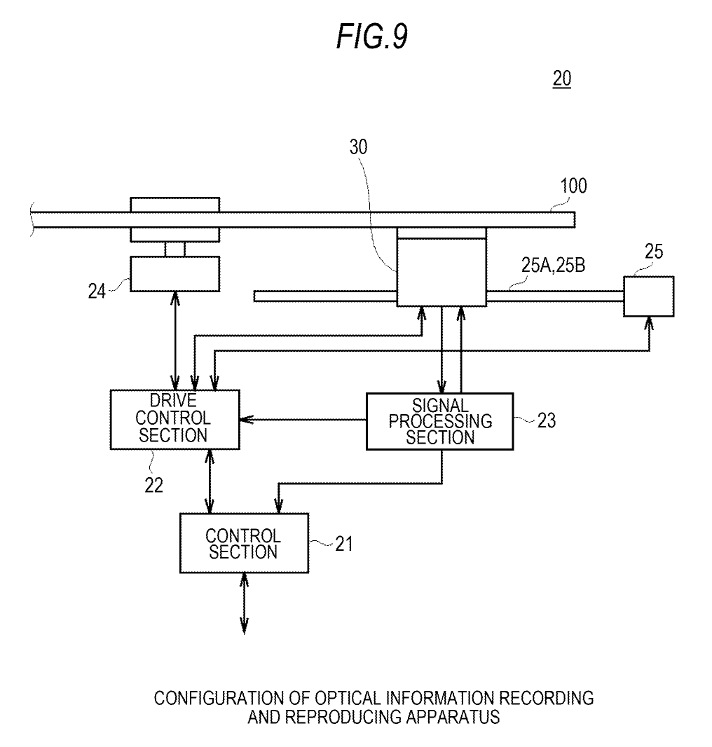

As shown in FIG. 9, the optical information recording and reproducing apparatus 20 is configured centering on a control section 21. The control section 21 is configured of a non-illustrated CPU (central processing unit), ROM (read only memory) having various programs and the like stored therein and RAM (random access memory) to be used as a work memory of the subject CPU.

When information is reproduced from the optical information recording medium 100, the control section 21 rotates and drives a spindle motor 24 via a drive control section 22 and rotates the optical information recording medium 100 placed on a prescribed turntable at a desired rate.

Also, the control section 21 works such that by driving a thread motor 25 via the drive control section 22, it largely moves an optical pickup 30 along moving axes 25A and 25B in the tracking direction, namely the direction toward the inner periphery side or outer periphery side of the optical information recording medium 100.

The optical pickup 30 is installed with plural optical parts such as an objective lens 40 and works so as to emit the servo light beam LS and the information light beam LM on the optical information recording medium 100 on the basis of control of the control section 21 and detect the servo reflected light beam LSr and the transmitted light beam LMo.

A signal processing section 23 works such that by subjecting a detected signal to prescribed arithmetic processing, demodulation processing and decoding processing and the like, it is able to reproduce the information recorded as the recording mark RM on the target track TG of the target mark layer YG.

### (1-5) Configuration of Optical Pickup

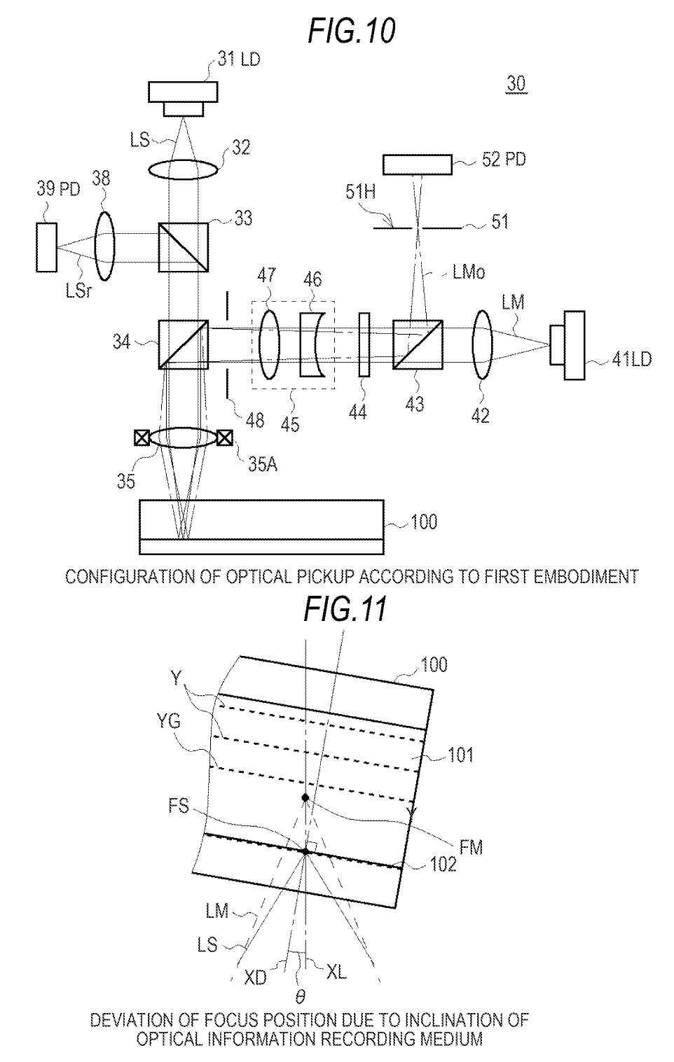

Next, the configuration of the optical pickup 30 is described. As shown in FIG. 10, this optical pickup 30 works so as to emit the servo light beam LS and the information light beam LM on the optical information recording medium 100.

### (1-5-1) Optical Path of Servo Light Beam

This optical pickup 30 works so as to irradiate the optical information recording medium 100 with the servo light beam LS emitted from a laser diode 31 and receive the servo reflected light beam LSr reflected by the subject optical information recording medium 100 by a photodiode 39.

In fact, the laser diode 31 emits the servo light beam LS composed of divergent light in a prescribed quantity of light on the basis of control of the control section 21 (see FIG. 9) and makes it incident into a collimator lens 32. The collimator lens 32 converts the servo light beam LS from the divergent light to parallel light and makes it incident into a beam splitter 33.

The beam splitter 33 makes the servo light beam LS transmit therethrough and makes it incident into a dichroic prism 34. The dichroic prism 34 makes the servo light beam LS transmit therethrough depending upon the wavelength of the light beam and makes it incident into the objective lens 35.

The objective lens 35 condenses the servo light beam LS and allows it to irradiate the servo layer 102 of the optical information recording medium 100. At that time, as shown in FIGS. 8A and 8B, the servo light beam LS is reflected in the servo layer 102 to form the servo reflected light beam LSr going toward the opposite direction to the servo light beam LS.

Thereafter, the servo reflected light beam LSr is converted to parallel light by the objective lens 35 and then made incident into the dichroic prism 34. The dichroic prism 34 makes the servo reflected light beam LSr transmit therethrough and makes it incident into the beam splitter 33. The beam splitter 33 reflects the servo reflected light beam LSr and makes it incident into a condensing lens 38.

The condensing lens 38 converges the servo reflected light beam LSr and allows it to irradiate the photodiode 39.

Now, in the optical information recording and reproducing apparatus 20, since there is a possibility that face wobbling or the like is caused in the rotating optical information recording medium 100, the relative position of the desired servo track to the objective lens 35 is possibly fluctuated.

For that reason, in order to make the focus FS (see FIG. 8B) of the servo light beam LS follow the target track TG, it is required to move the subject focus FS to the focus direction which is a neighboring direction or isolated direction to the optical information recording medium 100 and the tracking direction which is the inner periphery side direction or outer periphery side direction of the optical information recording medium 100.

Then, the objective lens 35 works such that it can be driven in the two axial directions including the focus direction and the tracking direction by a biaxial actuator 35A.

Also, in the optical pickup 30, optical positions of various optical parts are regulated such that the focused state when the servo light beam LS is condensed by the objective lens 35 and irradiates the servo layer 102 of the optical information recording medium 100 is reflected in the focused state when the servo light beam LSr is condensed by the condensing lens 38 and irradiates the photodiode 39.

The photodiode 39 has four detection regions divided in a lattice form on the surface which is irradiated with the servo reflected light beam LSr. The photodiode 39 works so as to detect a part of the servo reflected light beam LSr in each of the four detection regions and produce four servo detected signals, respectively depending upon the quantity of light detected at that time and send them to the signal processing section 23 (see FIG. 9).

The signal processing section 23 produces a focus error signal SFE and a tracking error signal STE expressing deviations in the focus direction and the tracking direction, respectively from the desired servo track in the servo layer 102 of the servo light beam LS on the basis of the servo detected signals and feeds them into the drive control section 22.

The drive control section 22 produces an actuator drive current on the basis of the focus error signal SFE and the tracking error signal STE and feeds it into the biaxial actuator 35A. According to this, the biaxial actuator 35A works so as to displace the objective lens 35 such that the servo light beam LS is focused at the desired servo track.

### (1-5-2) Optical Path of Information Light Beam

On the other hand, the optical pickup 30 works so as to irradiate the optical information recording medium 100 with the information light beam LM emitted from a laser diode 41 and receive the transmitted light beam LMo in a photodiode 52.

That is, the laser diode 41 works such that it is able to emit blue laser light having a wavelength of about 405 nm. In fact, the laser diode 41 emits the information light beam LS composed of divergent light in a prescribed quantity of light on the basis of control of the control section 21 (see FIG. 9) and makes it incident into a collimator lens 42. The collimator lens 42 converts the information light beam LS from the divergent light to parallel light and makes it incident into a polarizing beam splitter 43.

The polarizing beam splitter 43 makes the information light beam LM composed of P-polarized light by the polarizing direction of the light beam transmit therethrough and makes it incident into a ¼ wavelength plate 44. The ¼ wavelength plate 44 converts the information light beam LM from P-polarized light into circularly polarized light and makes it incident into a relay lens 45.

The relay lens 45 converts the information light beam LM from parallel light to convergent light by a moving lens 46, regulates the degree of convergence or divergence of the subject information light beam LM which has been converted to divergent light after the convergence (this state will be hereinafter referred to as “convergent state”) by a fixed lens 47 and makes it incident into the dichroic prism 34 through an aperture 48.

Here, the moving lens 46 works so as to be moved in the optical axis direction of the information light beam LM by an actuator (not illustrated). In fact, the relay lens 45 works such that the degree of divergence or convergence of the information light beam LM to be emitted from the fixed lens 47 (this state will be hereinafter referred to as “convergent state”) can be changed by moving the moving lens 46 by the actuator on the basis of the control of the drive control section 22 (see FIG. 9).

The dichroic prism 34 reflects the subject information light beam LM depending upon the wavelength and makes it incident into the objective lens 35. The objective lens 35 condenses the information light beam LM and allowing it to irradiate the optical information recording medium 100. As that time, as shown in FIGS. 8A and 8B, the information light beam LM is focused within the recording layer 101.

Here, the position of the focus FM of the subject information light beam LM is determined depending upon the convergent state at the time when it is emitted from the fixed lens 47 of the relay lens 45. That is, the focus FM moves in the focus direction within the recording layer 101 depending upon the position of the moving lens 46.

In fact, the optical pickup 30 works so as to regulate the depth d of the focus FM (see FIGS. 8A and 8B) of the information light beam LM within the recording layer 101 of the optical information recording medium 100 (namely, the dept d is corresponding to the distance from the servo layer 102) by controlling the moving lens 46 by the drive control section 22 (see FIG. 9), thereby making the focus FM in conformity with the target track TG.

In this way, the optical pickup 30 makes the tracking direction of the focus FM of the information light beam LM in conformity with the target track TG by emitting the information light beam LM through the objective lens 35 having been servo controlled on the basis of the servo light beam LS. Furthermore, the optical pickup 30 works so as to make the focus direction of the focus FM in conformity with the target track TG by regulating the depth d of the subject focus FM (see FIGS. 8A and 8B) depending upon the position of the moving lens 46 in the relay lens 45.

Then, at the time of recording processing of recording information on the optical information recording medium 100, the information light beam LM is condensed as the recording light beam LMw onto the focus FM by the objective lens 35, thereby forming the recording mark RM on the subject focus FM.

On the other hand, at the time of reproducing processing of reading the information recorded in the optical information recording medium 100, the information light beam LM is condensed as the read-out light beam LMe onto the focus FM by the objective lens 35 and thereafter, becomes the transmitted light beam LMo, which is then reflected by the servo layer 102 and made incident into the objective lens 35.

The objective lens 35 converges the transmitted light beam LMo to some extent and makes it incident into the dichroic prism 34. The dichroic prism 34 reflects the transmitted light beam LMo depending upon the wavelength and makes it incident into the relay lens 45 through the aperture 48.

The relay lens 45 alters the convergent state of the transmitted light beam LMo and makes it incident into the ¼ wavelength plate 44. The ¼ wavelength plate 44 converts the transmitted light beam LMo composed of circularly polarized light to S-polarized light and makes it incident into the polarizing beam splitter 43.

The polarizing beam splitter 43 reflects the transmitted light beam LMo composed of S-polarized light and allows it to irradiate the photodiode 52 through a pinhole plate 51.

Here, since pinhole plate 51 is disposed such that a focus of the transmitted light beam LMo is positioned within an opening 51H, the subject transmitted light beam LMo passes therethrough as it is.

On the other hand, the pinhole plate 51 substantially intercepts light with a different focus, which is reflected, for example, from the surface of the recording layer 101 in the optical information recording medium 100, the recording mark RM existing in the mark layer Y which is different from the target mark layer YG, or the like (this light will be hereinafter referred to as “stray light”). As a result, the photodiode 52 does not substantially detect the quantity of light of the stray light LN.

As a result, the photodiode 52 produces the transmitted light receiving signal depending upon the quantity of light of the transmitted light beam LMo as an information detected signal without being affected by the stray light LN and feeds it into the signal processing section 23 (see FIG. 9).

The signal processing section 23 works so as to reproduce information by performing prescribed filtering processing or demodulation processing or the like against the information detected signal.

In this way, the optical pickup 30 works so as to receive the transmitted light beam LMo which is made incident from the optical information recording medium 100 into the objective lens 35 and feed the result of light receiving into the signal processing section 23.

Now, the optical pickup 30 is provided with the aperture 48 between the relay lens 45 and the dichroic prism 34. At the time of recording processing, the aperture 48 makes the recording light beam LMw transmit therethrough as it is. That is, the aperture 48 makes the recording light beam LMw pass therethrough in a state that its luminous flux size is larger than an effective diameter of the objective lens 35.

On the other hand, at the time of reproduction, the aperture 48 restricts the aperture of the read-out light beam LMe to be made incident. That is, the aperture 48 makes the recording light beam LMw pass therethrough in a state that the aperture is less than the effective diameter of the objective lens 35. According to this, the aperture 48 works so as to make the objective lens 35 act as a lens with a numerical aperture (for example, 0.6) which is smaller than the actual numerical aperture (for example, 0.85).

In other words, the optical pickup 30 works such that when an angle formed between the optical axis XL of the light beam to be condensed and an outer peripheral portion of the subject light beam (in the vicinity of the focus, a virtual line connecting to the focus in the drawing) is defined as a converging angle α (see FIG. 5), a converging angle α of the read-out light beam LMe is smaller than a converging angle α of the recording light beam LMw.

According to this, the optical pickup 30 is able to make a spot size of the read-out light beam LMe at the focus FM larger than a spot size of the recording light beam LMw at the focus FM. Also, the optical pickup 30 is able to make a depth of focus of the read-out light beam LMe large.

Here, in the optical pickup 30, there may be the case where the optical information recording medium 100 is inclined against the optical information recording and reproducing apparatus 20 due to so-called face wobbling or the like.

For example, as shown in FIG. 11, in the case where a normal line XD against the optical information recording medium 100 is inclined by an angle θ against the optical axis XL, a gap between the standard layer 102 and the target mark layer YG on the optical axis XL is made (1/cos θ) times adistance DG between the focus FS and the focus FM, whereby it becomes different from the subject distance DG.

However, since the optical pickup 30 is able to make the depth of focus of the read-out light beam LMe large, even in the case where the recording mark RM is deviated in the focus direction, the optical pickup 30 works so as to be able to generate the good transmitted light beam LMo.

Also, since the normal line XD is deviated from the optical axis XL, even by focusing the servo light beam LS at the desired servo track, the focus FM of the information light beam LM is deviated from the center of the target track TG.

That is, at the time of recording information, when a tilt is generated in the optical information recording medium 100, the optical pickup 30 forms the recording mark RM at a position deviated from the target mark position at which the recording mark RM is to be originally formed. Also, at the time of reproducing information, when a tilt is generated in the optical information recording medium 100, the optical pickup 30 positions the focus FM of the read-out light beam LMe at a position deviated from the target mark position where the recording mark RM exists.

However, at the time of reproducing information, since the optical pickup 30 is able to make the spot size of the read-out light beam LMe large, the optical pickup 30 works so as to be able to surely irradiate the recording mark RM with the read-out light beam LMe and generate the good transmitted light beam LMo.

As a result, the optical information recording and reproducing apparatus 20 works so as to be able to produce a reproduced signal with high quality on the basis of the good transmitted light beam LMo.

In this way, at the time of reproducing information, by making the numerical aperture of the objective lens 35 small to condense the read-out light beam LMe, the optical pickup 30 is able to make the spot size and depth of focus of the read-out light beam LMe. As a result, the optical pickup 30 works so as to be able to relieve a harmful influence to be caused due to the fact that the target mark position is deviated depending upon the tilt of the optical information recording medium 100.

### (1-6) Operation and Result

In the foregoing configuration, the optical information recording and reproducing apparatus 20 condenses the information light beam LM as first light which is emitted from the laser diode 41 as a light source by the objective lens 35 and irradiates the optical information recording medium 100 having the uniform recording layer 101 with the information light beam LM. At that time, the optical information recording and reproducing apparatus 20 emits the information light beam LM to the target track TG as a track having formed therein the recording mark RM for intercepting the information light beam LM and receives the transmitted light beam LMo as transmitted light having transmitted through the subject track TR.

According to this, the optical information recording and reproducing apparatus 20 is able to detect the presence or absence of the recording mark RM on the target track TG on the basis of the quantity of light of the transmitted light beam LMo, which increases or decreases upon being intercepted by the subject recording mark RM.

Here, in conventional type optical discs having a signal recording layer, such as BD (Blu-ray Disc; a registered trademark) and DVD (digital versatile disc), since the signal recording layer composed of a plane is irradiated with the read-out light beam, the majority of the subject read-out light beam can be reflected in an opposite direction by the signal recording layer. For that reason, in the conventional optical discs, the majority of the subject read-out light beam is reflected as return light traveling in the opposite direction to the read-out light beam, whereby return light with a relatively large quantity of light can be generated.

Contrary to this, in the optical information recording medium 100, since the recording mark RM having a three-dimensional shape is formed in the uniform recording layer 101, when the subject recording mark RM is irradiated with the read-out light beam LMo, the subject read-out light beam LMe is reflected diffusely. For that reason, in the optical information recording medium 100, only a slight quantity of the return light beam LMt can be generated. For that reason, the return light beam LMt causes a large fluctuation in the quality of light by a slight position change, for example, a deviation of the recording mark RM in the focus direction, etc.

On the other hand, the transmitted light beam LMo is composed of light which has not been intercepted by the recording mark RM and is able to express the presence or absence of the recording mark RM as a large change in the quantity of light to be caused due to interception regardless of a trend of the intercepted light. For that reason, since the transmitted light beam LMo is small in a change in the quality of light to be caused due to the position fluctuation of the recording mark RM as a change in the quality of light to be caused due to interception, the transmitted light beam LMo is not largely influenced by a slight position change of the recording mark RM.

That is, in the optical information recording and reproducing apparatus 20, by producing a reproduced RF signal on the basis of the transmitted light beam LMo, it is possible to produce a reproduced RF signal with high quality, in which a slight change of the recording mark RM does not substantially appear as a noise. As a result, the optical information recording and reproducing apparatus 20 is able to detect the presence or absence of the recording mark RM in a high precision from the reproduced RF signal and precisely reproduce information.

Also, in the optical information recording and reproducing apparatus 20, at the time of forming the recording mark RM, the luminous flux size of the recording light beam LMw as first light is regulated at the effective diameter of the objective lens 35 or more, whereas at the time of reproducing information, the luminous flux size of the read-out light beam LMe is regulated at less than the effective diameter of the objective lens 35, by the aperture 48 as a luminous flux size restricting section.

According to this, in the optical information recording and reproducing apparatus 20, at the time of recording information, the objective lens 35 can act as a lens having an original numerical aperture, whereas at the time of reproducing information, the objective lens 35 can act as a lens having a numerical aperture smaller than the original numerical aperture. That is, the optical information recording and reproducing apparatus 20 is able to condense the read-out light beam LMe at a converging angle α smaller than that of the recording light beam LMw emitted at the time of forming the recording mark RM.

As a result, in the optical information recording and reproducing apparatus 20, the spot size and depth of focus of the read-out light beam LMe can be made large; and even in the case where the read-out light beam LMe irradiates a position deviated from the original target mark position, or in the case where the recording mark RM is formed deviated fromthe original target mark position, the recording mark RM can surely be irradiated with the read-out light beam LMe. As a result, in the optical information recording and reproducing apparatus 20, even in such cases, the information can be reproduced from the transmitted light beam LMo.

Furthermore, in the optical information recording and reproducing apparatus 20, when the transmitted light beam LMo is reflected by the servo layer 102 as a reflection layer which the optical information recording medium 100 possesses, the transmitted light beam LMo emitted from the side of the incident surface into which the read-out light beam LMe has been made incident (namely, the side of the recording layer 101) is received.

According to this, in the optical information recording and reproducing apparatus 20, since it may be sufficient to provide optical parts on only one side of the optical information recording medium 100, it is possible to reduce the size of the optical pickup 30 as compared with the case of receiving the transmitted light beam LMo emitted from the side of the substrate 103.

Also, in the optical information recording and reproducing apparatus 20, the servo light beam LS as second light, which is composed of an optical axis XL substantially the same as the optical axis of the read-out light beam LMe is condensed by the objective lens 35, and the objective lens 35 is driven such that the servo light beam LS is focused on the servo layer 102 which the optical information recording medium 100 possesses. In the optical information recording and reproducing apparatus 20, the focus FM of the read-out light beam LMe is isolated by an arbitrary distance from the focus FS of the servo light beam LS.

Here, in the optical information recording and reproducing apparatus 20, since the transmitted light beam LMo is received, there is a possibility that servo control cannot be performed in a manner similar to the servo control on the basis of reflected light. In the optical information recording and reproducing apparatus 20, the servo control is performed on the basis of the servo light beam LS, whereby the focus FM of the read-out light beam LMe can be adequately positioned at the target mark position which is determined on the basis of the servo layer 102 and to be irradiated with the subject read-out light beam LMe.

Furthermore, in the optical information recording and reproducing apparatus 20, the track TR having the recording mark RM formed thereon by modulating the refractive index by a bubble is irradiated with the read-out light beam LMe. Here, in the optical information recording medium 100 for forming the recording mark RM composed of a cavity, since the recording mark RM is formed by heat generated due to the irradiation with the recording light beam LMw, the optical information recording medium 100 has characteristics such that the position of the recording mark RM is easily fluctuated especially in the focus direction.

By applying the embodiment of the present invention to the optical information recording medium 100 having such characteristics, an effect for enhancing the quality of a reproduced RF signal can be revealed to a maximum extent.

According to the foregoing configuration, the optical information recording and reproducing apparatus 20 worked so as to receive the transmitted light beam LMo having transmitted through the track TR. According to this, the optical information recording and reproducing apparatus 20 was not intercepted by the recording mark RM. That is, a reproduced signal can be produced on the basis of the quantity of light of the transmitted light beam LMo, the quantity of light of which is largely reduced due to the presence of the recording mark RM. Thus, it is possible to realize an optical pickup capable of enhancing the quality of a reproduced signal, an optical information reproducing apparatus and an optical information reproducing method.

### (2) Second Embodiment

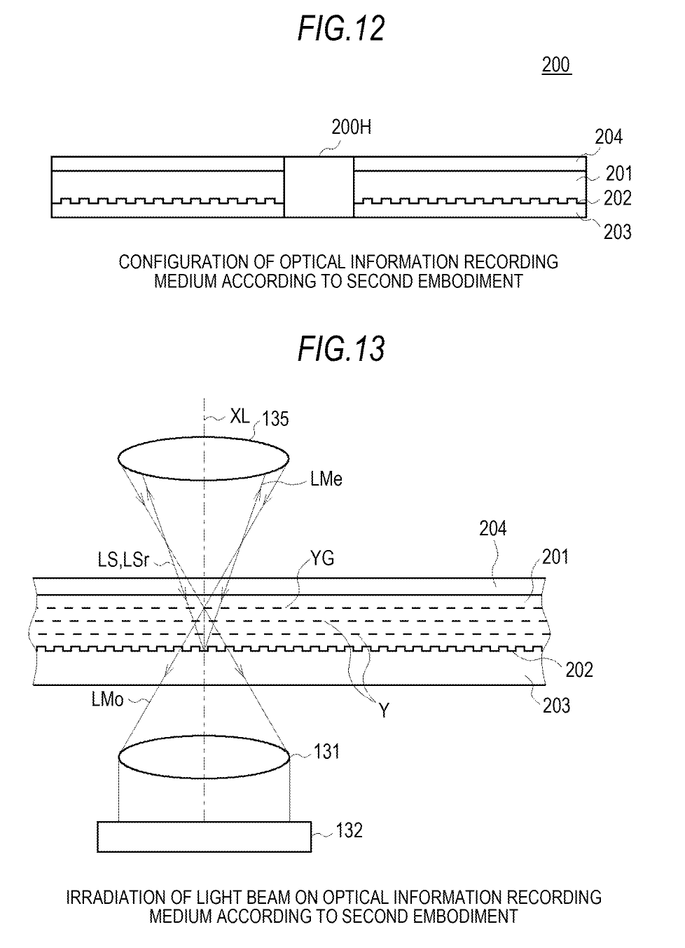

FIGS. 12 to 14 show a second embodiment, and proportions corresponding in the first embodiment as shown in FIGS. 1 to 11 are given the same symbols. The second embodiment is different from the first embodiment in points that an optical information reproducing apparatus 120 corresponding to the optical information recording and reproducing apparatus 20 performs only the reproduction of information and that the presence or absence of the recording mark RM is detected on the basis of the transmitted light beam LMo having transmitted through an optical information recording medium 200 corresponding to the optical information recording medium 100. A configuration as the optical information reproducing apparatus 120 is the same as in the optical information recording and reproducing apparatus 20, and therefore, its explanation is omitted.

### (2-1) Configuration of Optical Information Recording Medium

As shown in FIG. 12, the optical information recording medium 200 is configured such that a recording layer 201 corresponding to the recording layer 101 is interposed between a substrate 203 corresponding to the substrate 103 and a substrate 204. A configuration of the substrate 204 is the same as in the substrate 103. Also, the substrate 204 is not always necessary, and the recording layer 201 may configure the surface.

A servo layer 202 corresponding to the servo layer 102 is made of a dichroic film for reflecting the servo light beam LS having a wavelength of 660 nm and making the read-out light beam LMe having a wavelength of 405 nm transmit therethrough.

As shown in FIG. 13, the optical information recording medium 200 works so as to irradiate the servo layer 202 corresponding to the servo layer 102 with the servo light beam LS and drive an objective lens 135 corresponding to the objective lens 35 on the basis of the servo reflected light beam LSr having the servo light beam LS reflected therein by the subject servo layer 201.

Also, the optical information recording medium 200 is irradiated with the read-out light beam LMe on a target track TG from the side of the substrate 204 through the objective lens 135 and makes a transmitted light beam LMo having transmitted through the subject target track TG transmit therethrough by the servo layer 202. As a result, the transmitted light beam LMo transmits through the substrate 203 and emits from the optical information recording medium 200.

The optical information recording medium 200 works so as to be able to detect the presence or absence of the recording mark RM by receiving the transmitted light beam LMo in a photodiode 132 through a light receiving lens 131 disposed on the side of the substrate 203.

### (2-2) Configuration of Optical Pickup

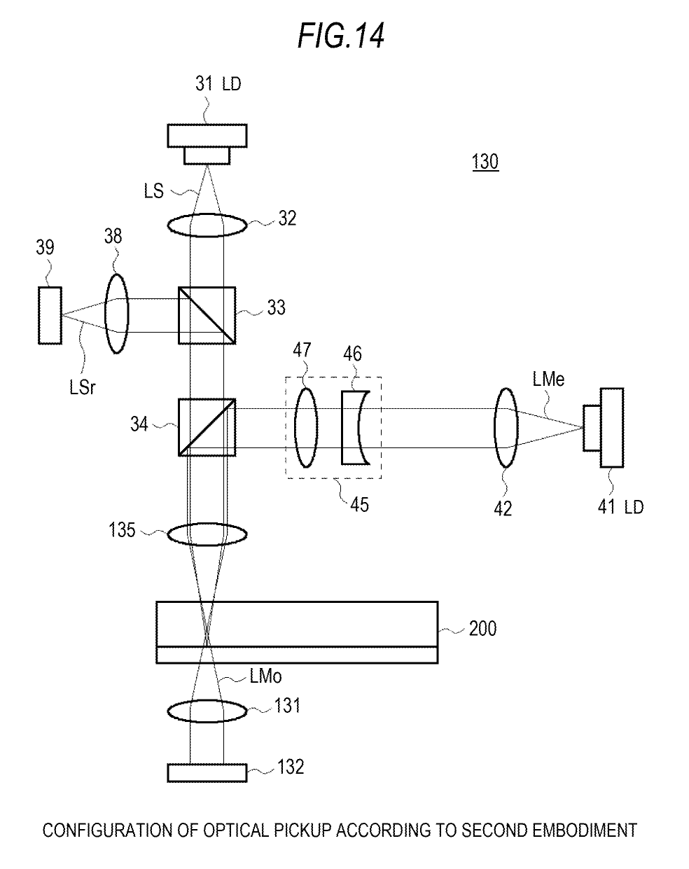

As shown in FIG. 14, an optical pickup 130 corresponding to the optical pickup 30 emits the servo light beam LS from the laser diode 31 and irradiates the servo layer 202 of the optical information recording medium 200 with the subject servo light beam LS through the collimator 32, the beam splitter 33, the dichroic prism 34 and the objective lens 135.

The optical pickup 130 works so as to receive the servo reflected light beam LSr by the photodiode 39 through the objective lens 135, the dichroic prism 34, the beam splitter 33 and the condensing lens 38.

Also, the optical pickup 130 emits the read-out light beam LMe from the laser diode 41 and irradiates the recording layer 201 of the optical information recording medium 200 with the subject read-out light beam LMe through the collimator 42, the relay lens 45, the dichroic prism 34 and the objective lens 135.

Here, in the optical information recording medium 200, it is supposed that the recording mark RM irradiated with the recording light beam LMw is formed using an objective lens having a numerical aperture of, for example, about 0.85. On the other hand, the objective lens 135 has a numerical aperture of, for example, about 0.6. For that reason, the optical pickup 130 works so as to be able to make the spot size and depth of focus of the read-out light beam LMe large similar to the first embodiment.

As shown in FIG. 13, the read-out light beam LMe transmits through the recording layer 201, the servo layer 202 and the substrate 203, is emitted as the transmitted light beam LMo from the optical information recording medium 200 and is made incident into the light receiving lens 131.

The light receiving lens 131 has a numerical aperture of, for example, about 0.6, converts the read-out light beam LMe to substantially parallel light and allows it to irradiates the photodiode 132. The photodiode 132 works such that when it receives the transmitted light beam LMo, it produces the transmitted light receiving signal as an information detected signal depending upon the light receiving amount.

In this way, the optical pickup 130 works so as to receive the transmitted light beam LMo having transmitted through the optical information recording medium 200 on the side of the substrate 203, which is the opposite side to the substrate 204 into which the read-out light beam LMe is made incident.

According to this, since the optical pickup 130 is able to make the optical path of the read-out light beam LMe and the optical path of the transmitted light beam LMo different from each other, optical parts for separating the optical path of the read-out light beam LMe and the optical path of the transmitted light beam LMo different from each other (for example, the polarizing beam splitter 43 and the ¼ wavelength plate 44 in the optical pickup 30) are not necessary. As a result, the optical pickup 130 works so as to be able to easily take such a configuration.

### (2-3) Operation and Result

In the foregoing configuration, the optical information reproducing apparatus 120 receives the transmitted light beam LMo emitted from the opposite side (namely, the side of the substrate 203) to the side of the incident surface (namely, the side of the substrate 204) into which the read-out light beam LMe has been made incident due to the fact that it transmits through the optical information recording medium 200.

According to this, since the optical information reproducing apparatus 120 may receive the transmitted light beam LMo which is emitted from the optical information recording medium 200 as it is without reflecting it, the number of optical parts in the optical pickup 130 can be reduced.

According to the foregoing configuration, by receiving the transmitted light beam LMo having transmitted through the optical information recording medium 200 as it is, the optical information reproducing apparatus 120 does not cause a reduction of the quantity of light of the transmitted light beam LMo on the optical path and an increase of noises. Therefore, the optical information reproducing apparatus 120 is able to receive the transmitted light beam LMo in the state that the presence or absence of the recording mark RM is expressed to a maximum extent.

### (3) Other Embodiments

In the foregoing first and second embodiments, while the case where the recording mark RM composed of a bubble is formed in each of the optical information recording media 100 and 200 has been described, it should not be construed that the present invention is limited to these embodiments. According to the embodiments of the present invention, the recording mark RM for intercepting the read-out light beam LMe may be formed in the optical information recording medium. For example, a recording mark RM for reflecting or diffracting the read-out light beam LMe by modulation of the refractive index, or a recording mark RM for absorbing the read-out light beam LMe, may be formed.

Also, in the foregoing first embodiment, while the case where the converging angle α of the read-out light beam LMe is smaller than the converging angle α of the recording light beam LMw has been described, it should not be construed that the present invention is limited thereto. The converging angle α of the read-out light beam LMe may be the same as the converging angle α of the recording light beam LMw.

Furthermore, in the foregoing first embodiment, while the case where the converging angle α of the read-out light beam LMe is smaller than the converging angle α of the recording light beam LMw by aperture restriction by the aperture 48 has been described, it should not be construed that the present invention is limited thereto. For example, the numerical aperture of the objective lens may be changed by switching two objective lenses having a different numerical aperture from each other.

Furthermore, in the foregoing first embodiment, while the case where the recording light beam LMw having a luminous flux size of the effective diameter of the objective lens 35 or more is made to pass through the aperture 48 as it is has been described, it should not be construed that the present invention is limited thereto. For example, the aperture 48 may be prepared such that the luminous flux size of the recording light beam LMw is substantially equal to the effective diameter of the objective lens 35.

Furthermore, in the foregoing first and second embodiments, while the case where the servo control of the objective lens 35 or 135 is performed on the basis of the servo light beam LS has been described, it should not be construed that the present invention is limited to these embodiments. The servo control of the objective lens 35 or 135 may be performed on the basis of the transmitted light beam LMo. In that case, by making the converging angle α of the read-out light beam LMe small, the precision of the servo control can be reduced at the time of reproducing information, whereby it is possible to reduce a load of the servo control.

Furthermore, in the foregoing first embodiment, while the case where the objective lens 35 works so as to act as a lens having a numerical aperture of 0.85 at the time of recording information, whereas the objective lens 35 works so as to act as a lens having a numerical aperture of 0.6 at the time of reproducing information has been described, it should not be construed that the present invention is limited thereto. Besides, the objective lens 35 can be made to act as a lens having a numerical aperture of every sort. The same is also applicable to the objective lens 135 in the second embodiment.

Furthermore, in the foregoing first and second embodiments, while the case where the wavelength of the servo light beam LS is different from that of the information light beam LM has been described, it should not be construed that the present invention is limited to these embodiments. For example, the light beam emitted from one laser diode may be separated into the servo light beam LS and the information light beam LM by a beam splitter or the like.

Furthermore, in the first and second embodiments, while the case where the wavelength of the servo light beam LS is 660 nm, and the wavelength of the information light beam LM is 405 nm has been described, it should not be construed that the present invention is limited to these embodiments. The wavelength of each of the servo light beam LS and the information light beam LM can be properly chosen.

Furthermore, the configurations of the first and second embodiments may be properly combined.

Furthermore, in the first embodiment, while the case where the optical pickup 30 is configured as an optical pickup including the laser diode 41 as a light source, the objective lens 35 as an objective lens and the photodiode 52 as a light receiving section has been described, it should not be construed that the present invention is limited thereto. The optical pickup according to an embodiment of the present invention may be composed of other configuration of every sort including a light source, an objective lens and a light receiving section.

Furthermore, in the foregoing first embodiment, while the case where the optical information recording and reproducing apparatus 20 is configured as an optical information reproducing apparatus including the laser diode 41 as a light source, the objective lens 35 as an objective lens, the photodiode 52 as a light receiving section and the signal processing section 23 as a signal processing section, it should not be construed that the present invention is limited thereto. The optical information reproducing apparatus according to an embodiment of the present invention may be composed of other configuration of every sort including a light source, an objective lens, a light receiving section and a signal processing section.

Furthermore, in the first embodiment, while the case where the optical information recording and reproducing apparatus 20 is configured as an optical information recording and reproducing apparatus including the laser diode 41 as a light source, the objective lens 35 as an objective lens, the photodiode 52 as a light receiving section and the aperture 48 as a luminous flux size control section, it should not be construed that the present invention is limited thereto. The optical information recording and reproducing apparatus according to an embodiment of the present invention may be composed of other configuration of every sort including a light source, an objective lens, a light receiving section and a luminous flux size control section.

Embodiments of the present invention can also be applied in an optical disc apparatus in which information of video images, voices, data for computer, etc. is recorded on an optical disc, and the subject information is reproduced from the subject optical disc.

The present application contains subject matter related to that disclosed in Japanese Priority Patent Application JP 2008-163475 filed in the Japan Patent Office on Jun. 23, 2008, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

1. An optical pickup comprising:
a light source that emits first light;
an objective lens that condenses the first light and allows it to irradiate a track having formed therein a recording mark for intercepting the first light in a uniform recording layer of an optical information recording medium; and
a light receiving section that receives transmitted light which has transmitted through the track.

2. The optical pickup according to claim 1, wherein the objective lens condenses the first light at a converging angle smaller than that of recording light emitted at a time of forming the recording mark.

3. The optical pickup according to claim 2, including
a luminous flux size control section in which a luminous flux size of the first light is substantially equal to or more than an effective diameter of the objective lens at the time of forming the recording mark, whereas the luminous flux size of the first light is less than the effective diameter of the objective lens at the time of reproducing information.

4. The optical pickup according to claim 1, wherein
the light receiving section receives the transmitted light emitted from a side of an incident surface into which the first light has been made incident by reflection of the transmitted light by a reflection layer which the optical information recording medium possesses.

5. The optical pickup according to claim 1, wherein
the light receiving section receives the transmitted light emitted from an opposite side to a side of an incident surface into which the first light has been made incident by transmission through the optical information recording medium.

6. The optical pickup according to claim 1, wherein
the objective lens condenses second light composed of substantially a same optical axis as an optical axis of the first light; and
the optical pickup further comprising
a drive section for driving the objective lens such that the second light is focused in a servo layer which the optical information recording medium possesses, and
a focus moving section for isolating a focus of the first light by an arbitrary distance from a focus of the second light.

7. The optical pickup according to claim 3, wherein
the objective lens allows the first light to irradiate the track having the recording mark formed therein by modulation of a refractive index.

8. The optical pickup according to claim 7, wherein
the objective lens allows the first light to irradiate the track having formed therein the recording mark composed of a cavity.

9. The optical pickup according to claim 8, wherein
the objective lens allows the first light to irradiate the track having formed therein the recording mark composed of the cavity by vaporization of a vaporizable material.

10. The optical pickup according to claim 9, wherein
the vaporizable material has a vaporization temperature of 140° C. or higher and not higher than 400° C.

11. An optical information reproducing apparatus comprising:
a light source that emits first light;
an objective lens for condensing the first light and allowing it to irradiate a track having formed therein a recording mark for intercepting the first light in a uniform recording layer of an optical information recording medium;
a light receiving section for receiving transmitted light which has transmitted through the track; and
a signal processing section for producing a reproduced signal based on the transmitted light.

12. An optical information reproducing method comprising steps of:
condensing first light and allowing it to irradiate a track having formed therein a recording mark for intercepting the first light in a uniform recording layer of an optical information recording medium; and
receiving transmitted light which has transmitted through the track.
